(19) United States
(12) Patent Application Publication
(10) Pub. No.: US 2003/0129938 A1
(43) Pub. Date: Jul. 10, 2003

(54) Ofspr

(76) Inventor: David E. Mitchell, Omaha, NE (US)

Correspondence Address: DAVID E. MITCHELL, 2518 MAPLE ST, OMAHA, NE, 68111, US

(21) Appl. No.: 10/079,147

(22) Filed: Jul. 11, 2002

Related U.S. Application Data
(60) Provisional application No. 60/271,932, filed on Feb. 26, 2001.

(51) Int. Cl. B01L 1/04; F24F 7/007; F24F 7/06; F24F 13/08

(52) U.S. Cl. 454/187; 454/341

(57) ABSTRACT

A vacuum airtight hard plastic room (like a room size food storage container) for portablity from hospital to hospital for a cancer free surgery, a plastic room (a giant plastic container) thats airtight, Vacuum to zero level oxygen, so when a incision is made during surgery to remove the cancer that is a spreadable cancer from oxygen, there is no oxygen to come Into contact with the cancer therefore the cancereous tissues could be remove successfully with out spreading further during surgery, the patient, doctors, nurses will be supplied with oxygen tanks, and mask, before and during surgery.

This application claims for priorty of the filing date of provisional application No. 60/271,932 filed on date of Feb. 26, 2001

### BACKGROUND OF THE INVENTION

1. Field of the Invention

The invention relates to vacuums as in vacuum cleaners or vacuum sealers

2. Description of the Prior Art

The invention relates particularly although not exclusively to vacuums It consist on combining vacuums to an airtight plastic room (a giant plastic container) for a Oxygen free surgery for a cancerous tissues removal operation so there Is no oxygen to come into contact with the cancer. (use for portability)

### BRIEF DESCRIPTION OF THE DRAWING

A airtight vacuum plastic room (a giant plastic container) according to the invention will Now be describe by the way of example with reference to the companying Drawing in which:

FIG. 1 is an isometric view of the left side in 3-D a airtight plastic room;

FIG. 2 is a schematic front side view of vacuums that vacuums from a round circular vent that connects to the airtight plastic room.

FIG. 3 is an isometric view of one of the vacuums that shows the air drawn Down and through the vacuum.

FIG. 4 is a schematric front view of four vacuums in an housing to vacuum from a round circular vent that connects to the airtight plastic room to vacuum to zero level oxygen.

### SUMMARY OF THE INVENTION

It is an object of the invention to overcome the obstacle of removing oxygen from a cancer operation that normanly is unsuccessful because usually the cancer Will spread to quickly during surgery because of the oxygen that Come into contact with the cancerous tissues according to the invention It will vacuum the oxygen out to zero oxygen level from a airtight plastic Room (a giant plastic container) for a oxygen free surgery therefore the cancerous tissues Can be remove successfully.

### DETAIL DESCRIPTION OF THE INVENTION

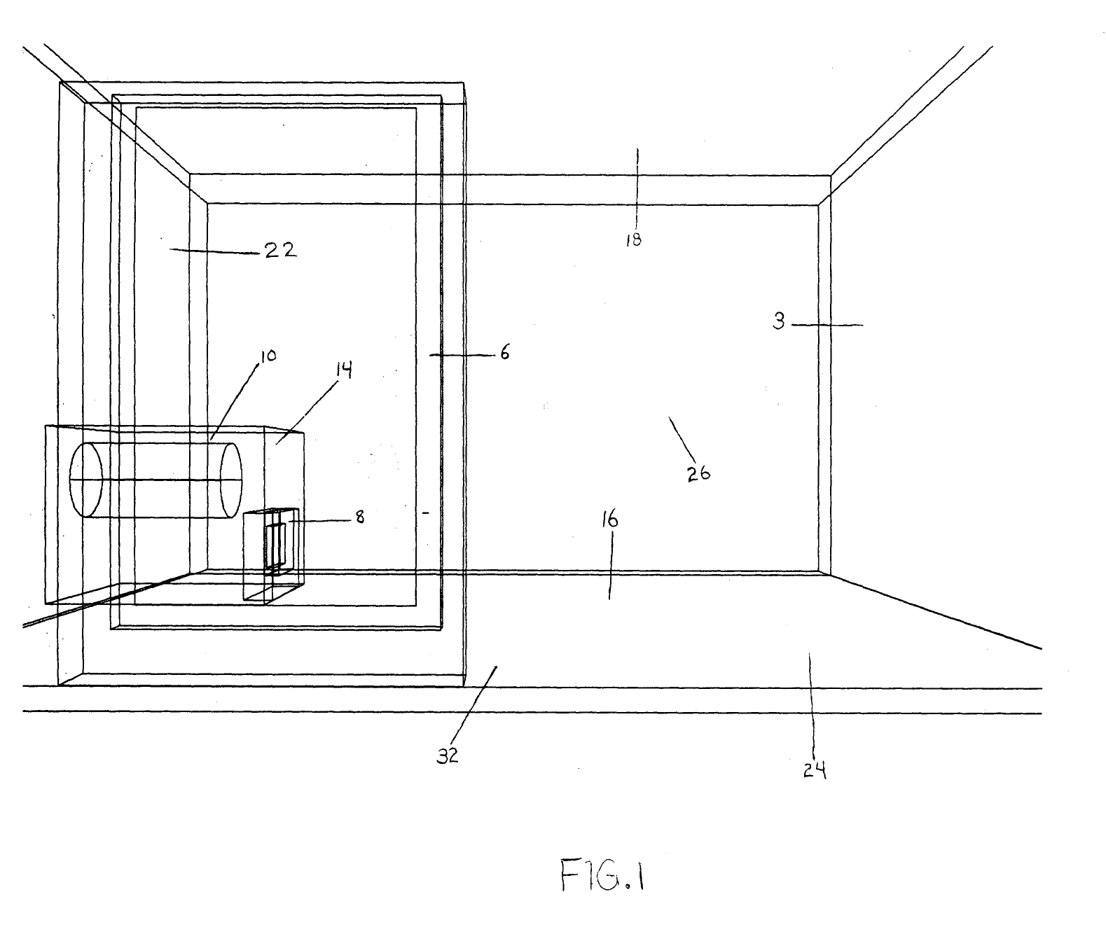

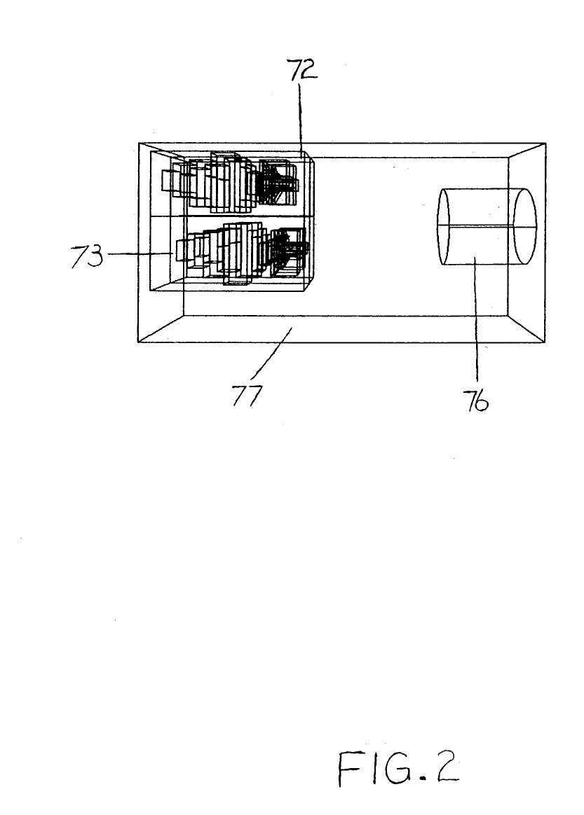

Referring to the drawing in FIG. 1, a vacuum airtight plastic room 24, an airtight plastic sealed door 6, a small vent airtight plastic sealed door 8, an airtight vent box 14, a vacuum round circular vent that connects to the actual vacuum round circular vent as in FIG. 2 10, a right side of the plastic room 22, a plastic ceiling 18, an left side of the plastic room 3, a plastic back wall 26, a plastic floor 16, a front plastic wall 32,

FIG. 2

one of four vacuums 73, a vacuum housing 72, an airtight vent box 77, a round circular vent that connects to the plastic room vent 76,

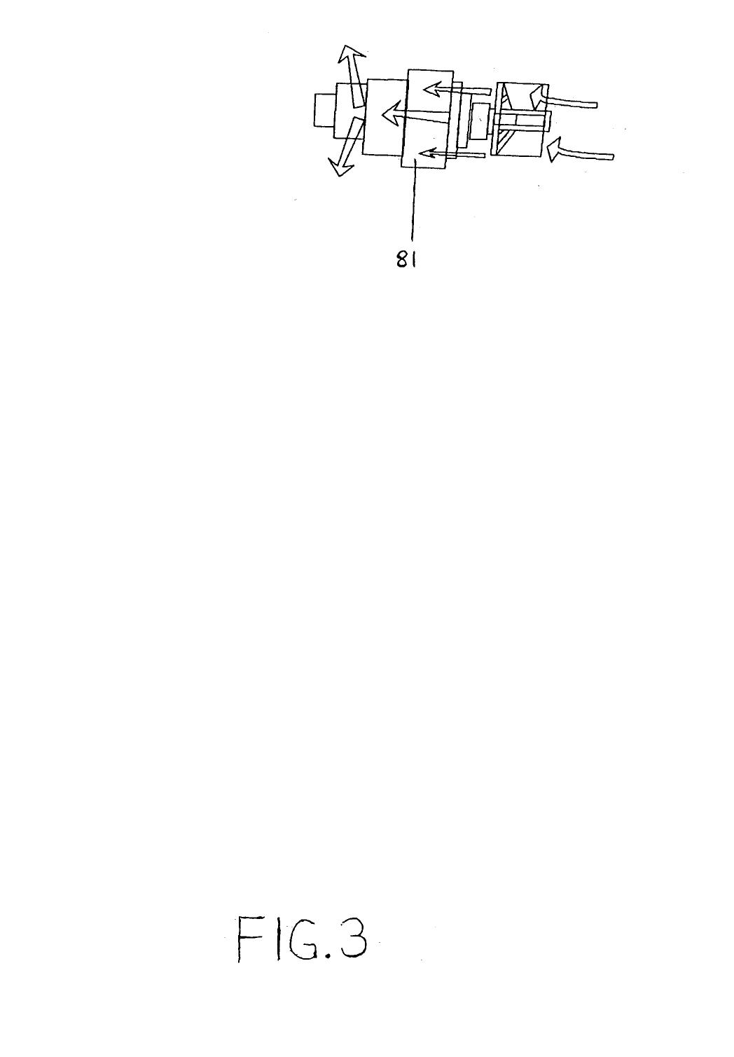

FIG. 3

a view of one of four vacuum that shows air suction drawn down and through the vacuum 81,

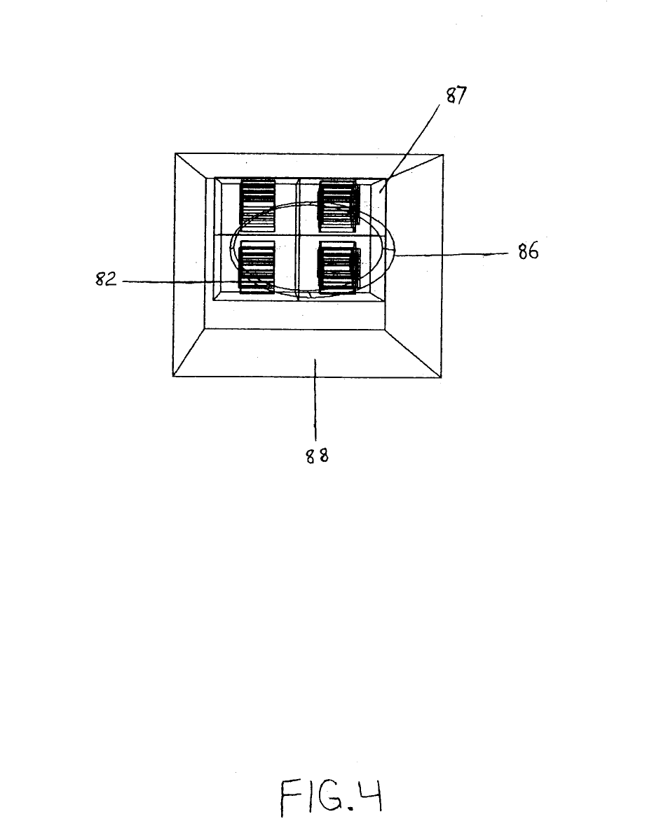

FIG. 4

one of four vacuums front view 82, an airtight vent box 88, a round circular vent that connects to the plastic room circular vent 86, a front view of the vacuum housing 87.

I claim:

1. A vacuum airtight plastic room for a oxygen free surgery for removing of cancerous tissues, the vacuum will vacuum all the oxygen out to zero level oxygen, by combining of the two, i claim, the combination Will help in removal of cancerous tissues successfully during surgery giving a step forward in cancer, the size and dimension can be change of the vacuum and of the plastic room or number of vacuums or typ of vacuums, therefore, i claim the combination of the vacuum and the airtight plastic room (a giant plastic container).
